(19) United States
(12) Patent Application Publication
(10) Pub. No.: US 2023/0318076 A1
(43) Pub. Date: Oct. 5, 2023

(54) ALL-SOLID-STATE BATTERY HAVING HIGH DURABILITY BY IMPROVEMENT IN THERMAL DISTRIBUTION AND METHOD FOR MANUFACTURING THE SAME

(71) Applicants: HYUNDAI MOTOR COMPANY, Seoul (KR); KIA CORPORATION, Seoul (KR)

(72) Inventors: Seon Hwa Kim, Cheongju-si (KR); Young Jin Nam, Suwon-si (KR); Sang Wan Kim, Anyang-si (KR); Hee Soo Kang, Seoul (KR); Jae Min Lim, Suwon-si (KR); Hong Suk Choi, Hwaseong-si (KR)

(73) Assignees: HYUNDAI MOTOR COMPANY, Seoul (KR); KIA CORPORATION, Seoul (KR)

(21) Appl. No.: 18/079,454

(22) Filed: Dec. 12, 2022

(30) Foreign Application Priority Data
Apr. 5, 2022 (KR) 10-2022-0041967

(51) Int. Cl. H01M 10/654; H01M 10/058; H01M 10/0525; H01M 4/13; H01M 4/62

(52) U.S. Cl. CPC H01M 10/654; H01M 10/058; H01M 10/0525; H01M 4/13; H01M 4/628; H01M 2004/021

(57) ABSTRACT

An all-solid-state battery includes an anode current collector, an intermediate layer disposed on a first surface of the anode current collector, a solid electrolyte layer disposed on the intermediate layer, a cathode active material layer disposed on the solid electrolyte layer and including a cathode active material, a cathode current collector disposed on the cathode active material layer, and a reinforcement layer disposed on a second surface of the anode current collector, and the reinforcement layer includes a first layer including a polymer, and a second layer including a thermally conductive material.

### CROSS-REFERENCE TO RELATED APPLICATION

The present application claims priority to Korean Patent Application No. 10-2022-0041967 filed on Apr. 5, 2022, the entire contents of which is incorporated herein for all purposes by this reference.

### BACKGROUND OF THE PRESENT DISCLOSURE

### Field of the Present Disclosure

The present disclosure relates to an all-solid-state battery having high durability by improvement in thermal distribution and a method for manufacturing the same.

### Description of Related Art

An all-solid-state battery is a three-layer stack including a cathode active material layer bonded to a cathode current collector, an anode active material layer bonded to an anode current collector, and a solid electrolyte layer interposed between the cathode active material layer and the anode active material layer.

In general, the anode active material layer includes a solid electrolyte conducting lithium ions in addition to an anode active material, such as graphite. The solid electrolyte has a greater specific gravity than a liquid electrolyte, and thus, the energy density of the all-solid-state battery is lower than that of a lithium ion battery using a liquid electrolyte.

In order to solve the above problem, i.e., to increase the energy density of the all-solid-state battery, research on application of lithium metal as an anode is underway. However, there are many obstacles to overcome, including research technical problems, such as interfacial bonding, growth of lithium dendrites, etc., and industrial technical problems, such as costs, large-scale production, etc.

Recently, research on an anodeless all-solid-state battery in which an anode is removed and lithium ions (Lit) are directly precipitated in the form of lithium metal on an anode current collector is ongoing.

A solid electrolyte has a great difference in lithium ion conductivity depending on temperature, and thus, the operating temperature of an all-solid-state battery has a great effect on the capacity, efficiency, etc. of the all-solid-state battery. The solid electrolyte used in the all-solid-state battery is not decomposed even when the all-solid-state battery is operated at a high temperature, in contrast to a lithium ion battery using a liquid electrolyte. The lithium ion conductivity of the solid electrolyte is increased at a high temperature, and thus, when a high-temperature operating system is implemented, an all-solid-state battery having improved characteristics, such as output, energy density, etc., compared to the conventional all-solid-state batteries, may be manufactured.

However, when a heating system is added to an all-solid-state battery, the volume of the all-solid-state battery is increased, and thus, the actual energy density of the entire all-solid-state battery including the heating system is reduced.

The information disclosed in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an all-solid-state battery which improves thermal distribution in a cell while minimizing increase in volume.

It is another object of the present disclosure to provide an all-solid-state battery which improves thermal distribution in a cell so as to improve properties, such as durability, capacity, etc.

In one aspect, the present disclosure provides an all-solid-state battery including an anode current collector, an intermediate layer disposed on one surface of the anode current collector, a solid electrolyte layer disposed on the intermediate layer, a cathode active material layer disposed on the solid electrolyte layer and including a cathode active material, a cathode current collector disposed on the cathode active material layer, and a reinforcement layer disposed on another surface of the anode current collector, wherein the reinforcement layer includes a first layer including a polymer, and a second layer including a thermally conductive material.

In an exemplary embodiment of the present disclosure, the first layer may contact the another surface of the anode current collector.

In another exemplary embodiment of the present disclosure, the first layer may include at least one selected from the group consisting of polyetherimide (PEI), polyether ether ketone (PEEK), polyether ketone (PEKK), polyphenylene oxide (PPO), polyphenylene sulfide (PPS), polybutylene terephthalate (PBT), polyethylene terephthalate (PET), lignin and combinations thereof.

In yet another exemplary embodiment of the present disclosure, the first layer may have a thickness of about 1 μm to 20 μm.

In yet another exemplary embodiment of the present disclosure, the second layer may include at least one selected from the group consisting of graphene, graphene oxide, reduced graphene oxide and combinations thereof.

In still yet another exemplary embodiment of the present disclosure, a ratio (T₂/T₁) of a thickness (T₂) of the second layer to a thickness (T₁) of the first layer may be about 0.33 to 10.

In a further exemplary embodiment of the present disclosure, the all-solid-state battery may comprise a reaction zone where electrochemical reactions occur, and a non-reaction zone where electrochemical reactions do not occur, the reaction zone may be a region where the cathode active material layer, the solid electrolyte layer and the intermediate layer overlap based on a cross-section of the all-solid-state battery, the non-reaction zone may be a remaining region other than the reaction area and a temperature difference between the reaction zone and the non-reaction zone may be less than about 4.8° C.

In another further exemplary embodiment of the present disclosure, an area of the cathode active material layer may be smaller than an area of the solid electrolyte layer or an area of the intermediate layer, and the area of the solid electrolyte layer may be equal to the area of the intermediate layer.

In yet another further exemplary embodiment of the present disclosure, the intermediate layer may include a carbon material, and a metal powder capable of alloying with lithium.

In yet another further exemplary embodiment of the present disclosure, the metal powder may include at least one selected from the group consisting of gold (Au), platinum (Pt), palladium (Pd), silicon (Si), silver (Ag), aluminum (Al), bismuth (Bi), tin (Sn), zinc (Zn) and combinations thereof.

In still yet another further exemplary embodiment of the present disclosure, the intermediate layer may have a thickness of about 1 μm to 10 μm.

In another aspect, the present disclosure provides a method for manufacturing an all-solid-state battery, including obtaining a reinforcement layer by forming a second layer including at least one selected from the group consisting of graphene, graphene oxide, reduced graphene oxide and combinations thereof, on a first layer including a polymer by radiating laser beams to the first layer, manufacturing a stack including an anode current collector, an intermediate layer disposed on one surface of the anode current collector, a solid electrolyte layer disposed on the intermediate layer, a cathode active material layer disposed on the solid electrolyte layer and including a cathode active material, and a cathode current collector disposed on the cathode active material layer, and adhering the reinforcement layer to another surface of the anode current collector such that the first layer contact the another surface of the anode current collector.

In an exemplary embodiment of the present disclosure, the laser beams may be carbon dioxide (CO₂) laser beams.

Other aspects and exemplary embodiments of the present disclosure are discussed infra.

The above and other features of the present disclosure are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 shows a cross-sectional view of an all-solid-state battery according to an exemplary embodiment of the present disclosure;

FIG. 2 shows a cross-sectional view of the all-solid-state battery shown in FIG. 1 in a charged state;

FIG. 3 shows a reaction zone and a non-reaction zone of the all-solid-state battery according to an exemplary embodiment of the present disclosure;

FIG. 4A shows temperatures of a reaction zone and non-reaction zone of an all-solid-state battery according to Example 1 depending on the SOC of the all-solid-state battery when the all-solid-state battery is charged and discharged;

FIG. 4B shows temperatures of a reaction zone and non-reaction zone of an all-solid-state battery according to Comparative Example 1 depending on the SOC of the all-solid-state battery when the all-solid-state battery is charged and discharged;

FIG. 4C shows temperatures of a reaction zone and non-reaction zone of an all-solid-state battery according to Comparative Example 2 depending on the SOC of the all-solid-state battery when the all-solid-state battery is charged and discharged; and

FIG. 5 shows capacity retentions of the all-solid-state batteries according to Example 1, Comparative Example 1 and Comparative Example 2.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments, it will be understood that the present description is not intended to limit the present disclosure(s) to those exemplary embodiments. On the contrary, the present disclosure(s) is/are intended to cover not only the exemplary embodiments, but also various alternatives, modifications, equivalents and other embodiments, which may be included within the spirit and scope of the present disclosure as defined by the appended claims.

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the present disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Furthermore, if such a range refers to integers, the range includes all integers from a minimum integer to a maximum integer, unless stated otherwise.

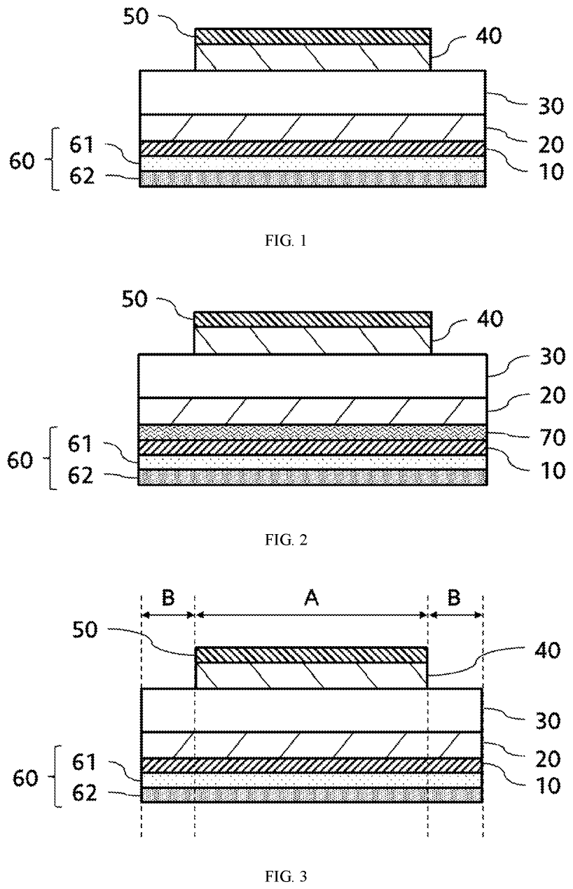

FIG. 1 shows a cross-sectional view of an all-solid-state battery according to an exemplary embodiment of the present disclosure. The all-solid-state battery may include an anode current collector 10, an intermediate layer 20 disposed on one surface of the anode current collector 10, a solid electrolyte layer 30 disposed on the intermediate layer 20, a cathode active material layer 40 disposed on the solid electrolyte layer 30 and including a cathode active material, and a cathode current collector 50 disposed on the cathode active material layer 40.

FIG. 2 shows a cross-sectional view of the all-solid-state battery shown in FIG. 1 in a charged state. The all-solid-state battery may include a lithium layer 70 between the anode current collector 10 and the intermediate layer 20.

In the all-solid-state battery, lithium ions may migrate to the intermediate layer 20 through the solid electrolyte layer 30 at the initial stage of charging. The lithium ions react with metal powder in the intermediate layer 20, and thus form a lithium alloy between the anode current collector 10 and the intermediate layer 20. When the all-solid-state battery continues to be charged, lithium is uniformly deposited or precipitated around the lithium alloy, and thereby, the lithium layer 70 is formed. The lithium layer 70 may include at least lithium metal.

The all-solid-state battery according to an exemplary embodiment of the present disclosure may include a reinforcement layer 60 disposed on another surface of the anode current collector 10. The reinforcement layer 60 having thermal conductivity may be adhered to the another surface of the anode current collector 10 so as to uniformize thermal distribution in the all-solid-state battery.

Referring to FIG. 3, the all-solid-state battery may include a reaction zone A where electrochemical reactions occur, and a non-reaction zone B where the electrochemical reactions do not occur. When the area of the cathode active material layer 40 is smaller than the area of the solid electrolyte layer 30 and the area of the intermediate layer 20, and the area of the solid electrolyte layer 30 is equal to the area of the intermediate layer 20, the reaction zone A may be a region where the cathode active material layer 40, the solid electrolyte layer 30 and the intermediate layer 20 overlap based on a cross-section of the all-solid-state battery, and the non-reaction zone B may be a remaining region other than the reaction zone A.

The reaction zone A where the electrochemical reactions for charging and discharging the all-solid-state battery occur emits heat, but the non-reaction zone B where the electrochemical reactions do not occur does not emit heat. Reactivity of the above-described reactions that form the lithium layer 70 is poor at a low temperature. Therefore, when thermal distribution is not uniform, the lithium layer 70 is nonuniformly deposited on the non-reaction zone B because it does not emit heat, thereby contributing to formation of lithium dendrites and causing problems, such as a crack in the solid electrolyte layer 30, short-circuit of the all-solid-state battery, etc.

The reinforcement layer 60 may transfer heat emitted in the reaction zone A to the non-reaction zone B, thereby being capable of achieving uniform thermal distribution in the all-solid-state battery.

The reinforcement layer 60 may include a first layer 61 including a polymer, and a second layer 62 including a thermally conductive material. The reinforcement layer 60 may be adhered to the anode current collector 10 such that the first layer 61 contacts the anode current collector 10.

The first layer 61 may be a source configured to form the second layer 62 thereon. The second layer 62 may be formed by radiating laser beams to the first layer 61, and a detailed description thereof will be given later. Furthermore, the first layer 61 may increase adhesiveness between the second layer 62 and the anode current collector 10.

The first layer 61 may include at least one selected from the group consisting of polyetherimide (PEI), polyether ether ketone (PEEK), polyether ketone (PEKK), polyphenylene oxide (PPO), polyphenylene sulfide (PPS), polybutylene terephthalate (PBT), polyethylene terephthalate (PET), lignin and combinations thereof.

The second layer 62 may include a thermally conductive material and, concretely, may include at least one selected from the group consisting of graphene, graphene oxide, reduced graphene oxide and combinations thereof. The second layer 62 may include laser induced graphene.

The ratio (T₂/T₁) of the thickness T₂ of the second layer 62 to the thickness T₁ of the first layer 61 may be about 0.33 to 10, about 0.33 to 5, about 0.33 to 4, or about 0.33 to 3. Furthermore, the thickness T₁ of the first layer 61 may be about 1 μm to 20 μm. When the ratio (T₂/T₁) of the thickness T₂ of the second layer 62 to the thickness T₁ of the first layer 61 is less than 0.33, the second layer 62 may be excessively thin, and may thus not sufficiently transfer heat emitted in the reaction zone A to the non-reaction zone B. When the ratio (T₂/T₁) of the thickness T₂ of the second layer 62 to the thickness T₁ of the first layer 61 exceeds an upper limit, i.e., 10, the second layer 62 may be excessively thick.

The anode current collector 10 may be a plate-shaped base material having electrical conductivity. The anode current collector 10 may be provided in the form of a sheet, a thin film or a foil.

The anode current collector 10 may include a material which does not react with lithium. The anode current collector 10 may include at least one selected from the group consisting of nickel (Ni), copper (Cu), stainless steel (SUS) and combinations thereof.

The intermediate layer 20 may include a carbon material, and a metal capable of alloying with lithium.

The carbon material may include amorphous carbon. The amorphous carbon is not limited to a specific material, and may include, for example, furnace black, acetylene black, Ketjen black or the like.

The metal may include at least one selected from the group consisting of gold (Au), platinum (Pt), palladium (Pd), silicon (Si), silver (Ag), aluminum (Al), bismuth (Bi), tin (Sn), zinc (Zn) and combinations thereof.

The solid electrolyte layer 30 is interposed between the cathode active material layer 40 and the anode current collector 10, and conduct lithium ions.

The solid electrolyte layer 30 may include a solid electrolyte having high lithium ion conductivity.

The solid electrolyte may include at least one selected from the group consisting of oxide-based solid electrolytes, sulfide-based solid electrolytes, polymer electrolytes and combinations thereof. Preferably, a sulfide-based solid electrolyte having high lithium ion conductivity may be used. The sulfide-based solid electrolytes may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), and Li₁₀GeP₂S₁₂, without being limited to a specific material.

The oxide-based solid electrolytes may include perovskite-type LLTO (Li₃ₓLa_{2/3-x}TiO₃), phosphate-based NASICON-type LATP (Li₁₊ₓAlₓTi₂₋ₓ(PO₄)₃), etc.

The polymer electrolytes may include gel polymer electrolytes, solid polymer electrolytes, etc.

The cathode active material layer 40 may reversibly store and emit lithium ions. The cathode active material layer 40 may include a cathode active material, a solid electrolyte, a conductive material, a binder, etc.

The cathode active material may include an oxide active material or a sulfide active material.

The oxide active material may include a rock salt layer-type active material, such as LiCoO₂, LiMnO₂, LiNiO₂, LiVO₂ or Li₁₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rock salt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M being at least one of Al, Mg, Co, Fe, Ni or Zn, and 0<x+y<2), or lithium titanate, such as Li₄Ti₅O₁₂.

The sulfide active material may include copper Chevrel, iron sulfide, cobalt sulfide, nickel sulfide or the like.

The solid electrolyte may include an oxide-based solid electrolyte or a sulfide-based solid electrolyte. Preferably, a sulfide-based solid electrolyte having high lithium ion conductivity may be used. The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), or Li₁₀GeP₂S₁₂, without being limited to a specific material.

The conductive material may include carbon black, conductive graphite, ethylene black, graphene or the like.

The binder may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC) or the like.

The cathode current collector 50 may be a plate-shaped base material having electrical conductivity. The cathode current collector 50 may include an aluminum foil.

A method for manufacturing an all-solid-state battery according to an exemplary embodiment of the present disclosure may include obtaining a reinforcement layer by forming a second layer on a first layer by radiating laser beams to the first layer, manufacturing a stack including an anode current collector, an intermediate layer disposed on one surface of anode current collector, a solid electrolyte layer, a cathode active material layer and a cathode current collector, and adhering the reinforcement layer to another surface of the anode current collector such that the first layer contacts the anode current collector.

The second layer may be formed by radiating carbon dioxide (CO₂) laser beams to the first layer. Radiation of the CO₂ laser beams may be performed under conditions, for example, a laser intensity of about 0.2 W/cm² to 60 W/cm², a wavelength of equal to or less than about 10.6 μm, a pulse duration of equal to or less than about 14 μs, and a beam size of about 120 μm, without being limited to specific conditions.

Formation of the stack is not limited to a specific method. The respective elements of the stack may be formed at the same time or at different times. For example, the method for manufacturing the all-solid-state battery according to an exemplary embodiment of the present disclosure may include not only forming the intermediate layer directly on the anode current collector, forming the solid electrolyte layer directly on the intermediate layer, forming the cathode active material layer directly on the solid electrolyte layer, and forming the cathode current collector directly on the cathode active material layer, but also separately preparing the respective elements and then stacking the respective elements into the structure shown in FIG. 1.

Adhesion of the reinforcement layer to the anode current collector is not limited to a specific method. For example, the reinforcement layer may be located on the other surface of the anode current collector, and then, heat and pressure sufficient to not damage the stack and the reinforcement layer may be applied thereto.

Hereinafter, the present disclosure will be described in more detail through the following examples. The following examples serve merely to exemplarily describe the present disclosure, and are not intended to limit the scope of the present disclosure.

### Example 1

A reinforcement layer including a first layer and a second layer was prepared by forming the second layer including laser induced graphene by radiating carbon dioxide (CO₂) laser beams to the first layer including polyetherimide (PEI). The ratio (T₂/T₁) of the thickness T₂ of the second layer to the thickness T₁ of the first layer was adjusted to about 0.71.

A stack having the structure shown in FIG. 1 was prepared, and then, the reinforcement layer was adhered to the other surface of an anode current collector of the stack such that the first layer contacts the anode current collector. Thereby, an all-solid-state battery was manufactured.

### Example 2

An all-solid-state battery was manufactured in the same manner as in Example 1 except that the ratio (T₂/T₁) of the thickness T₂ of a second layer to the thickness T₁ of a first layer was adjusted to about 1.67.

### Example 3

An all-solid-state battery was manufactured in the same manner as in Example 1 except that the ratio (T₂/T₁) of the thickness T₂ of a second layer to the thickness T₁ of a first layer was adjusted to about 0.45.

### Example 4

An all-solid-state battery was manufactured in the same manner as in Example 1 except that the ratio (T₂/T₁) of the thickness T₂ of a second layer to the thickness T₁ of a first layer was adjusted to about 0.33.

### Comparative Example 1

An all-solid-state battery without a reinforcement layer was manufactured.

### Comparative Example 2

An all-solid-state battery was manufactured in the same manner as in Example 1 except that a reinforcement layer including only a first layer without a second layer was adhered to the other surface of an anode current collector.

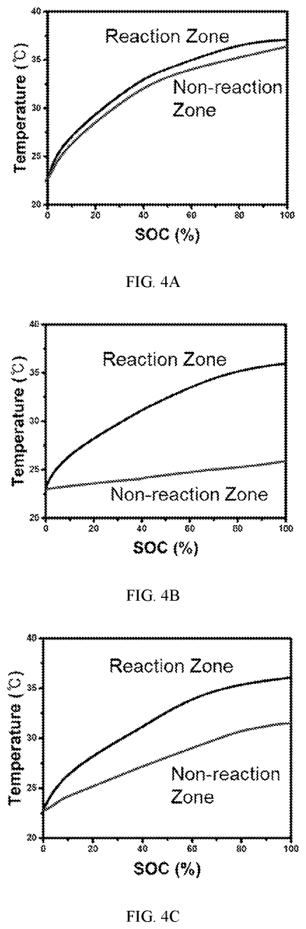

FIG. 4A shows temperatures of a reaction zone and a non-reaction zone of the all-solid-state battery according to Example 1 depending on the SOC of the all-solid-state battery when the all-solid-state battery is charged and discharged. The reaction zone is the center of the cathode active material layer based on a plane basis, and the non-reaction zone is the edge of the cathode active material layer other than the center thereof based on the plane basis.

FIG. 4B shows temperatures of a reaction zone and a non-reaction zone of the all-solid-state battery according to Comparative Example 1 depending on the SOC of the all-solid-state battery when the all-solid-state battery is charged and discharged.

FIG. 4C shows temperatures of a reaction zone and a non-reaction zone of the all-solid-state battery according to Comparative Example 2 depending on the SOC of the all-solid-state battery when the all-solid-state battery is charged and discharged.

Referring to FIG. 4A to 4C, it may be confirmed that the all-solid-state battery without a reinforcement layer according to Comparative Example 1 exhibited a very great temperature difference between the reaction zone and the non-reaction zone. For example, the temperature difference between the reaction zone and the non-reaction zone was about 10° C., when the SOC of the all-solid-state battery was 100%. It may be confirmed that the all-solid-state battery according to Comparative Example 2 exhibited a reduced temperature difference between the reaction zone and the non-reaction zone, compared to the all-solid-state battery according to Comparative Example 2, but the temperature difference between the reaction zone and the non-reaction zone was about 5° C., when the SOC of the all-solid-state battery was 100%, and thus, thermal distribution was still poor. On the other hand, it may be confirmed that the all-solid-state battery according to Example 1 exhibited very little temperature difference between the reaction zone and the non-reaction zone, and thus, thermal distribution in the all-solid-state battery was considerably uniform.

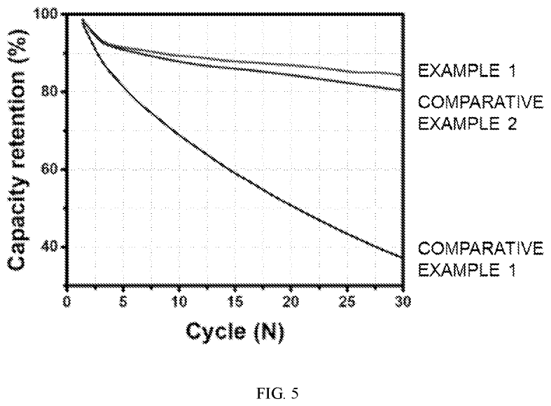

FIG. 5 shows capacity retentions of the all-solid-state batteries according to Example 1, Comparative Example 1 and Comparative Example 2. Referring to this figure, it may be confirmed that the all-solid-state battery according to Example 1 maintained a capacity of about 85% when charging and discharging of the all-solid-state battery were performed 30 times.

Table 1 below shows measurement results of temperature differences between the reaction zones and the non-reaction zones of the all-solid-state batteries according to Example 1 to Example 4. The temperature differences were measured when the SOCs of the corresponding all-solid-state batteries were 100%. For comparison, the results of the all-solid-state battery according to Comparative Example 2 were set forth.

TABLE 1

| | | Temp. difference between |
|---|---|---|
| | Thickness ratio | reaction zone and |
| Category | (T₂/T₁) | non-reaction zone [° C.] |
| Example 2 | 1.67 | 0.7 |
| Example 1 | 0.71 | 1.2 |
| Example 3 | 0.45 | 2.3 |
| Example 4 | 0.33 | 4.4 |
| Comparative example 2 | — | 4.8 |

Referring to Table 1 above, the all-solid-state battery according to Example 2 having the ratio (T₂/T₁) of the thickness T₂ of the second layer to the thickness T₁ of the first layer, which was 1.67, exhibited a temperature difference of about 0.7° C. between the reaction zone and the non-reaction zone, i.e. very uniform thermal distribution.

As is apparent from the above description, the present disclosure may provide an all-solid-state battery which improves thermal distribution in a cell while minimizing increase in volume.

The all-solid-state battery according to an exemplary embodiment of the present disclosure may improve thermal distribution in the cell, thereby being capable of improving properties, such as durability, capacity, etc.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. An all-solid-state battery comprising:
an anode current collector;
an intermediate layer disposed on one surface of the anode current collector;
a solid electrolyte layer disposed on the intermediate layer;
a cathode active material layer disposed on the solid electrolyte layer and comprising a cathode active material;
a cathode current collector disposed on the cathode active material layer; and
a reinforcement layer disposed on another surface of the anode current collector,
wherein the reinforcement layer comprises a first layer comprising a polymer, and a second layer comprises a thermally conductive material.

2. The all-solid-state battery of claim 1, wherein the first layer contacts the another surface of the anode current collector.

3. The all-solid-state battery of claim 1, wherein the first layer comprises at least one of polyetherimide, polyether ether ketone, polyether ketone ketone, polyphenylene oxide, polyphenylene sulfide, polybutylene terephthalate, polyethylene terephthalate, lignin or any combination thereof.

4. The all-solid-state battery of claim 1, wherein the first layer has a thickness of about 1 μm to 20 μm.

5. The all-solid-state battery of claim 1, wherein the second layer comprises at least one of graphene, graphene oxide, reduced graphene oxide or any combination thereof.

6. The all-solid-state battery of claim 1, wherein a ratio (T₂/T₁) of a thickness (T₂) of the second layer to a thickness (T₁) of the first layer is about 0.33 to 10.

7. The all-solid-state battery of claim 1,
wherein the all-solid-state battery comprises a reaction zone where electrochemical reactions occur, and a non-reaction zone where electrochemical reactions do not occur,
wherein the reaction zone is a region where the cathode active material layer, the solid electrolyte layer and the intermediate layer overlap based on a cross-section of the all-solid-state battery,
wherein the non-reaction zone is a remaining region other than the reaction area, and
wherein a temperature difference between the reaction zone and the non-reaction zone is less than about 4.8° C.

8. The all-solid-state battery of claim 7,
wherein an area of the cathode active material layer is smaller than an area of the solid electrolyte layer or an area of the intermediate layer; and
wherein the area of the solid electrolyte layer is equal to the area of the intermediate layer.

9. The all-solid-state battery of claim 1, wherein the intermediate layer comprises a carbon material, and a metal powder capable of alloying with lithium.

10. The all-solid-state battery of claim 9, wherein the metal powder comprises at least one of gold (Au), platinum (Pt), palladium (Pd), silicon (Si), silver (Ag), aluminum (Al), bismuth (Bi), tin (Sn), zinc (Zn) or any combination thereof.

11. The all-solid-state battery of claim 1, wherein the intermediate layer has a thickness of about 1 μm to 10 μm.

12. A method for manufacturing an all-solid-state battery, the method comprising:
obtaining a reinforcement layer by forming a second layer on a first layer comprising a polymer by radiating laser beams to the first layer, wherein the second layer comprises graphene, graphene oxide, reduced graphene oxide or any combination thereof;
manufacturing a stack comprising an anode current collector, an intermediate layer disposed on one surface of the anode current collector, a solid electrolyte layer disposed on the intermediate layer, a cathode active material layer disposed on the solid electrolyte layer and comprising a cathode active material, and a cathode current collector disposed on the cathode active material layer; and
adhering the reinforcement layer to another surface of the anode current collector such that the first layer contacts the another surface of the anode current collector.

13. The method of claim 12, wherein the laser beams are carbon dioxide (CO₂) laser beams.

14. The method of claim 12, wherein the first layer comprises at least one of polyetherimide, polyether ether ketone, polyether ketone ketone, polyphenylene oxide, polyphenylene sulfide, polybutylene terephthalate, polyethylene terephthalate, lignin or any combination thereof.

15. The method of claim 12, wherein the first layer has a thickness of about 1 μm to 20 μm.

16. The method of claim 12, wherein a ratio (T₂/T₁) of a thickness (T₂) of the second layer to a thickness (T₁) of the first layer is about 0.33 to 10.

17. The method of claim 12,
wherein the all-solid-state battery comprises a reaction zone where electrochemical reactions occur, and a non-reaction zone where electrochemical reactions do not occur,
wherein the reaction zone is a region where the cathode active material layer, the solid electrolyte layer and the intermediate layer overlap based on a cross-section of the all-solid-state battery,
wherein the non-reaction zone is a remaining region other than the reaction area, and
wherein a temperature difference between the reaction zone and the non-reaction zone is less than about 4.8° C.

18. The method of claim 17,
wherein an area of the cathode active material layer is smaller than an area of the solid electrolyte layer or an area of the intermediate layer; and
wherein the area of the solid electrolyte layer is equal to the area of the intermediate layer.

19. The method of claim 12,
wherein the intermediate layer comprises a carbon material, and a metal powder capable of alloying with lithium, and
wherein the metal powder comprises at least one of gold (Au), platinum (Pt), palladium (Pd), silicon (Si), silver (Ag), aluminum (Al), bismuth (Bi), tin (Sn), zinc (Zn) or any combination thereof.

20. The method of claim 12, wherein the intermediate layer has a thickness of about 1 μm to 10 μm.
